(19) United States
(12) Patent Application Publication
(10) Pub. No.: US 2019/0035334 A1
(43) Pub. Date: Jan. 31, 2019

(54) DISPLAY PANEL, DISPLAY DEVICE AND COMPENSATING METHOD

(71) Applicant: BOE TECHNOLOGY GROUP CO., LTD., Beijing (CN)

(72) Inventors: Yi-Cheng LIN, Beijing (CN); Quanhu LI, Beijing (CN); Cuili GAI, Beijing (CN); Yu WANG, Beijing (CN); Mingi CHU, Beijing (CN); Chien Pang HUANG, Beijing (CN)

(21) Appl. No.: 15/781,937

(22) PCT Filed: Dec. 4, 2017
(86) PCT No.: PCT/CN2017/114398

§ 371 Date: Jun. 6, 2018

(30) Foreign Application Priority Data
May 12, 2017 (CN) 201710335194.4

(51) Int. Cl. G09G 3/3258; G09G 3/3275; G09G 3/3266

(52) U.S. Cl. CPC G09G 3/3258; G09G 3/3275; G09G 2300/0426; G09G 2320/0295; G09G 3/3266

(57) ABSTRACT

A display panel, a display device and a compensating method are disclosed. The display panel includes: a plurality of sub-pixels arranged in rows and columns, each of the sub-pixels includes a pixel circuit; a plurality of sensing driving lines respectively connected with pixel circuits of the plurality of sub-pixels; and a sensing driver connected with the plurality of sensing driving lines. The pixel circuit includes a light emitting element, the sensing driver is configured to sense electrical parameters of light emitting elements of the pixel circuits of the plurality of sub-pixels through the plurality of sensing driving lines, and the sensing driver is configured to generate compensation signals according to the electrical parameters, and transmit the compensation signals to the pixel circuits of the plurality of sub-pixels through the plurality of sensing driving lines.

### TECHNICAL FIELD

Embodiments of the present disclosure relate to a display panel, a display device and a compensating method.

### BACKGROUND

In the field of display, organic light emitting diode (OLED) display panels have the characteristics of autoluminescence, high contrast, low power consumption, wide viewing angle, rapid response speed, capability of being applied in flexible panels, wide service temperature range, simple production, etc., and have a wide development prospect.

Due to the above characteristics, the organic light emitting diode (OLED) display panels can be applicable to devices with display function such as mobile phones, displays, notebook computers, digital cameras, and instruments and meters.

### SUMMARY

At least one embodiment of the present disclosure provides a display panel, and the display panel comprises: a plurality of sub-pixels arranged in rows and columns, each of the sub-pixels comprising a pixel circuit; a plurality of sensing driving lines respectively connected with pixel circuits of the plurality of sub-pixels; and a sensing driver connected with the plurality of sensing driving lines. The pixel circuit comprises a light emitting element, the sensing driver is configured to sense electrical parameters of light emitting elements of the pixel circuits of the plurality of sub-pixels through the plurality of sensing driving lines, and the sensing driver is configured to generate compensation signals according to the electrical parameters, and transmit the compensation signals to the pixel circuits of the plurality of sub-pixels through the plurality of sensing driving lines.

For example, a display panel according to an embodiment further comprises a plurality of data lines connected with the pixel circuits of the plurality of sub-pixels, and each of the data lines is connected with pixel circuits of at least two sub-pixels in a same row.

For example, a display panel according to an embodiment further comprises a plurality of gate lines connected with the pixel circuits of the plurality of sub-pixels, and pixel circuits of the sub-pixels in each row are connected with a same gate line.

For example, a display panel according to an embodiment further comprises a plurality of gate lines connected with the pixel circuits of the plurality of sub-pixels, pixel circuits of the sub-pixels in a (2m−1)th row and pixel circuits of the sub-pixels in a (2m)th row are connected with a same gate line, and m is an integer greater than zero.

For example, in a display panel according to an embodiment, pixel circuits of the sub-pixels in each column are connected with a same sensing driving line.

For example, in a display panel according to an embodiment, the plurality of data lines extend in a same direction as the plurality of sensing driving lines.

For example, in a display panel according to an embodiment, only the data line or only the sensing driving line is arranged between pixel circuits of every two columns of the sub-pixels.

For example, in a display panel according to an embodiment, the plurality of data lines are formed in the same layer as the plurality of sensing driving lines.

For example, in a display panel according to an embodiment, pixel circuits of the sub-pixels in a (2n−1)th column and pixel circuits of the sub-pixels in a (2n)th column are connected with a same data line, and n is an integer greater than zero.

For example, in a display panel according to an embodiment, the pixel circuit further comprises: a light emitting driving circuit, configured to drive the light emitting element to emit light during operation, and a sensing diving control circuit, configured to control connection and disconnection of the sensing driving line with the light emitting driving circuit in the pixel circuit.

For example, in a display panel according to an embodiment, the light emitting driving circuit comprises a first transistor, a second transistor and a storage capacitor. A first electrode of the first transistor is connected with a first power supply line to receive a first power supply voltage, a gate electrode of the first transistor is connected with a first node, and a second electrode of the first transistor is connected with a second node; a first electrode of the second transistor is connected with the data line to receive a data signal, a gate electrode of the second transistor is connected with a gate line to receive a gate driving signal, and a second electrode of the second transistor is connected with the first node; a first end of the storage capacitor is connected with the first node, and a second end of the storage capacitor is connected with the second node.

For example, in a display panel according to an embodiment, the sensing diving control circuit comprises a third transistor. A first electrode of the third transistor is connected with a second node, a gate electrode of the third transistor is connected with a sensing driving control line to receive a sensing driving control signal, and a second electrode of the third transistor is connected with the sensing driving line.

For example, a display panel according to an embodiment further comprises: a data driver, configured to provide data signals to the pixel circuits; and a scan driver, configured to provide gate driving signals to the pixel circuits.

For example, in a display panel according to an embodiment, the light emitting element is an organic light emitting diode, the electrical parameters comprise a light emitting current or a light emitting voltage of the organic light emitting diode, and the compensation signals comprise a compensation voltage or a compensation current.

At least one embodiment of the present disclosure provides a display device, comprising any one of the above-described display panels.

At least one embodiment of the present disclosure provides a compensating method of any one of the above-described display panels, comprising: sensing the electrical parameters of the light emitting elements through the sensing driving lines; generating the compensation signals according to the electrical parameters; and transmitting the compensation signals to the pixel circuits through the sensing driving lines.

For example, a compensating method according to at least one embodiment, before sensing the electrical parameters of the light emitting elements, further comprising: transmitting data signals to the pixel circuits through the data lines.

### BRIEF DESCRIPTION OF THE DRAWINGS

In order to clearly illustrate the technical solution of the embodiments of the disclosure, the drawings used in the embodiments or description of related technologies will be briefly described in the following; it is obvious that the described drawings are only related to some embodiments of the disclosure and thus are not limitative of the disclosure.

FIG. 1 is a schematic diagram of a display panel provided by an embodiment of the present disclosure;

FIG. 2 is a first schematic diagram of the connection relationship between pixel circuits in the region A of FIG. 1 provided by the embodiment of the present disclosure;

FIG. 3 is a second schematic diagram of the connection relationship between pixel circuits in the region A of FIG. 1 provided by the embodiment of the present disclosure;

FIG. 4 is a third schematic diagram of the connection relationship between pixel circuits in the region A of FIG. 1 provided by the embodiment of the present disclosure;

FIG. 5 is a first schematic diagram of a pixel circuit in a display panel provided by the embodiment of the present disclosure;

FIG. 6A is a second schematic diagram of a pixel circuit in a display panel provided by the embodiment of the present disclosure;

FIG. 6B is a third schematic diagram of a pixel circuit in a display panel provided by the embodiment of the present disclosure;

FIG. 7 is a schematic diagram of sensing a current flowing through a first transistor in the pixel circuit shown in FIG. 6A;

FIG. 8 is a schematic diagram of sensing a light emitting voltage of the organic light emitting diode in the pixel circuit shown in FIG. 6A;

FIG. 9 is a schematic diagram of a display device provided by an embodiment of the present disclosure;

FIG. 10 is a first flowchart of a compensation method provided by an embodiment of the present disclosure; and

FIG. 11 is a second flowchart of a compensation method provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

For example, in an organic light emitting diode (OLED) display panel, the threshold voltages of the driving transistors in respective pixel circuits may differ from each other due to a manufacturing process. Furthermore, due to the influence of, for example, temperature variation, the threshold voltages of the driving transistors also suffer from drift phenomenon. Thus, the difference among the threshold voltages of the driving transistors may also result in nonuniform display of the display panel. Therefore, it is necessary to compensate the threshold voltages of the driving transistors.

For the pixel circuits in the display panel, the threshold compensation for the driving transistors in the pixel circuits can be realized by sensing light emitting currents or light emitting voltages of the organic light emitting diodes. When the above-described compensating method is adopted, it is necessary to provide sensing lines. Parasitic capacitance occurs between the sensing lines and other lines (for example, gate lines or data lines), thereby increasing the RC load of the circuits and reducing the sensing speed, which can easily lead to an insufficient sensing time period.

On the other hand, an aperture ratio of the display panel can affect the brightness of the display panel. Therefore, how to increase the aperture ratio of the display panel is also a problem to be solved.

A display panel, a display device and a compensating method provided by at least one embodiment of the present disclosure can increase the aperture ratio and reduce the parasitic capacitance by sharing data lines between adjacent pixel circuits, and perform the operation of sensing on the light emitting currents or the light emitting voltages of the organic light emitting diodes by sharing sensing driving lines and compensating for the threshold voltage drift of the driving transistors.

At least one embodiment of the present disclosure provides a display panel, and the display panel includes: a plurality of sub-pixels arranged in rows and columns, each of the sub-pixels comprising a pixel circuit; a plurality of sensing driving lines respectively connected with pixel circuits of the plurality of sub-pixels; and a sensing driver connected with the plurality of sensing driving lines. The pixel circuit includes a light emitting element, the sensing driver is configured to sense electrical parameters of light emitting elements of the pixel circuits of the plurality of sub-pixels through the plurality of sensing driving lines, and the sensing driver is configured to generate compensation signals according to the electrical parameters, and transmit the compensation signals to the pixel circuits of the plurality of sub-pixels through the plurality of sensing driving lines.

At least one embodiment of the present disclosure provides a display panel, and the display panel includes: a plurality of sub-pixels arranged in an array, each of the sub-pixels include a pixel circuit; sensing driving lines connected with pixel circuits; data lines each connected with at least two pixel circuits in a same row; and a sensing driver connected with the sensing driving lines. The pixel circuit includes an organic light emitting diode, the sensing driver is configured to sense a light emitting current or a light emitting voltage of the organic light emitting diode, and the sensing driver is configured to generate a compensation voltage according to the light emitting current or the light emitting voltage, and transmit the compensation voltage to the pixel circuit through the sensing driving line.

For example, sensing the light emitting current of the light emitting element (for example, an organic light emitting diode) refers to sense the light emitting current that is about to flow through or is flowing through the organic light emitting diode; sensing the light emitting voltage of the light emitting element (for example, an organic light emitting diode) refers to sense the voltage of an anode when the organic light emitting diode is emitting light.

In the following, the display panel is described with an organic light emitting diode display panel as an example, but embodiments of the present disclosure are not limited thereto. For example, the light emitting element can also be other kind of electroluminescent element such as an inorganic light emitting diode.

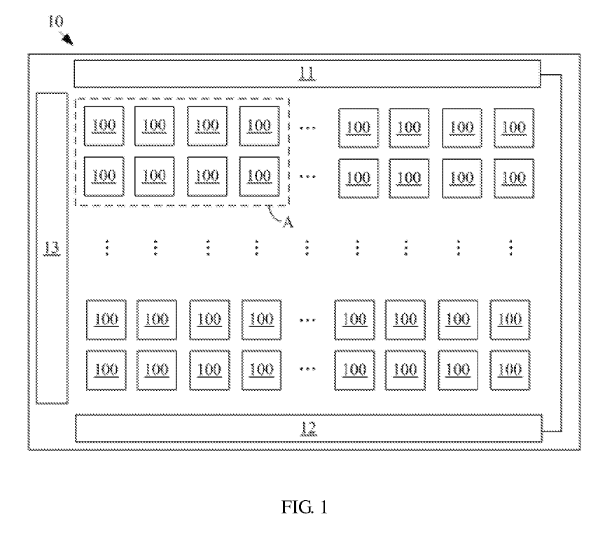

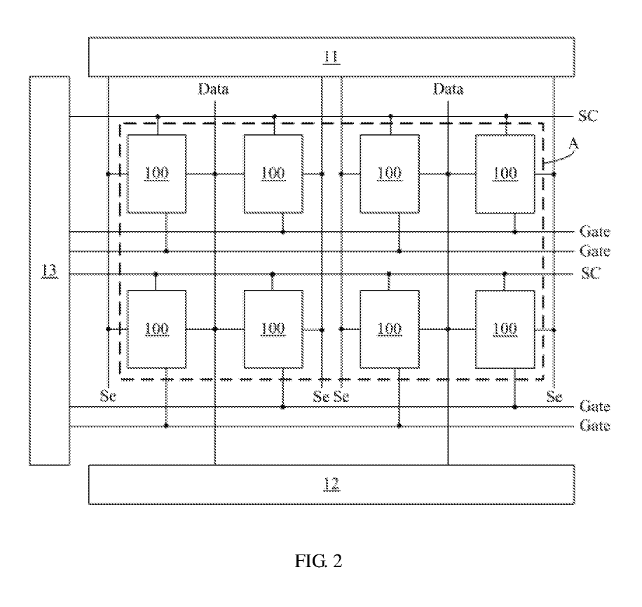

For example, FIG. 1 is a schematic diagram of a display panel provided by an embodiment of the present disclosure; FIG. 2 is a first schematic diagram of the connection relationship between pixel circuits in the region A of FIG. 1 provided by the embodiment of the present disclosure.

For example, as shown in FIG. 1 and FIG. 2, a display panel 10 provided by an embodiment of the present disclosure includes a plurality of sub-pixels arranged in an array, and the sub-pixels are arranged in rows and columns. The sub-pixels can be arranged in regular rows and columns, that is, the sub-pixels are all aligned with each other in the row and column directions, and can also be arranged in irregular rows and columns, for example, two adjacent rows or two adjacent columns can shift from each other by a predetermined distance (for example, half the width or height of a sub-pixel), which is not limited by the embodiments of the present disclosure. Each sub-pixel includes a pixel circuit 100, and the pixel circuit 100 includes a light emitting element such as an organic light emitting diode. The display panel 10 further includes a data driver 11, a sensing driver 12, a scan driver 13, data lines Data, gate lines Gate, and sensing driving lines Se. In FIG. 1 and FIG. 2, the plurality of data lines Data extend parallel to each other and extend longitudinally, the plurality of gate lines Gate extend parallel to each other and extend laterally, and the plurality of sensing driving lines Se extend parallel to each other and extend longitudinally.

For example, the data driver 11 is configured to provide data signals to the pixel circuits 100. The sensing driver 12 is configured to sense electrical parameters of light emitting elements (for example, organic light emitting diodes) through the sensing driving lines Se, and the electrical parameters, for example, are light emitting currents or light emitting voltages of the light emitting elements. The sensing driver 12 is also configured to generate compensation signals according to the sensed light emitting currents or light emitting voltages, and transmit the compensation signals to the pixel circuits 100 through the sensing driving lines Se. For example, the compensation signals are compensation currents or compensation voltages. The scan driver 13 is configured to provide gate driving signals to the pixel circuits 100.

For example, each data line Data is connected with pixel circuits 100 of at least two sub-pixels in a same row and the data driver 11. The data driver 11 is configured to provide data signals to the pixel circuits 100 of at least two sub-pixels in the same row through the same data line Data.

For example, in a display panel provided by at least one embodiment of the present disclosure, the pixel circuits 100 of each column of sub-pixels can be connected with a same sensing driving line Se, and the sensing driver 12 can sense electrical parameters (light emitting currents or light emitting voltages) of light emitting elements in the pixel circuits 100 of sub-pixels in a same column through the sensing driving line Se, for example, in a time-sharing manner. The sensing driver 12 can also generate compensation signals (for example, compensation currents or compensation voltages) according to the sensed electrical parameters, and transmit the compensation signals to the column pixel circuits 100 through the sensing driving line Se, for example, in a time-sharing manner, which can control luminous intensity of the light emitting elements.

For example, the data driver 11, the sensing driver 12 and the scan driver 13 can be respectively implemented by an application-specific integrated circuit chip and can also be implemented by a circuit or software, hardware (circuit), firmware or any combination thereof. For example, in at least one embodiment, the data driver 11 and the sensing driver 12 can be implemented by same one integrated circuit chip. The scan driver 13 is implemented by a GOA (gate on array) gate driving circuit and thus can be directly fabricated on the display panel. The scan driver 13 can also be implemented by an integrated circuit chip and then electrically connected with gate lines through a printed circuit board (for example, a flexible printed circuit board) or the like.

Moreover, for example, the sensing driver 12 can include a processor and a memory. In the embodiments of the present disclosure, the processor can process data signals and can include a variety of computational structures, e.g., a complex instruction set computer (CISC) structure, a reduced instruction set computing (RISC) structure or a structure that incorporates a plurality of instruction set combinations. In some embodiments, the processor can also be a microprocessor, e.g., an X86 processor or an ARM processor, and can also be a digital signal processor (DSP), etc. The processor can control other components to execute desired functions. In the embodiments of the present disclosure, the memory can store instructions and/or data executed by the processor. For example, the memory can include one or more computer program products. The computer program products can include various kinds of computer readable storage media, e.g., volatile memory and/or nonvolatile memory. Volatile memory, for example, includes a random access memory (RAM) and/or a cache memory. Nonvolatile memory, for example, includes read-only memory (ROM), hard disk, flash memory, etc. One or more computer program instructions can be stored in the computer readable storage medium. The processor can execute the program instructions to realize the desired functions (implemented by the processor) in the embodiments of the present disclosure. Various applications and various data, e.g., data used and/or produced by the applications, can also be stored in the computer readable storage media.

For example, the display panel 10 further includes a controller (not shown in figures), the controller is coupled with the data driver 11, the sensing driver 12 and the scan driver 13, and is configured to provide control instructions and/or timing signals to the data driver 11, the sensing driver 12 and the scan driver 13, whereby the data driver 11, the sensing driver 12 and scan driver 13 cooperate with each other. For example, the controller can also be implemented by a circuit or software, hardware (circuit), firmware or any combination thereof. For example, the controller is a timing controller (T-CON) for receiving image data inputted from outside of the display panel, providing decoded image data to the data driver, and outputting scan control signals and data control signals to the gate driver and the data driver.

For example, the data driver 11 and the sensing driver 12 can be connected together to facilitate data interaction between the sensing driver 12 and the data driver 11.

For example, in a display panel provided by at least one embodiment of the present disclosure, the pixel circuit 100 of the (2n−1)th column sub-pixels and the pixel circuit 100 of the (2n)th column sub-pixels in a same row are connected with a same data line Data, and n is an integer greater than zero.

For example, as shown in FIG. 2, two pixel circuits 100 connected to the same data line Data in the same row are respectively connected with two different gate lines Gate. For another example, in the same row, the pixel circuit 100 of the (2n−1)th column sub-pixels is connected with a gate line Gate, and the pixel circuit 100 of the adjacent (2n)th column sub-pixels is connected with another gate line Gate, and the two gate lines can be arranged adjacent to each other, for example, arranged between two adjacent rows of sub-pixels. This arrangement enables the pixel circuits 100 of the (2n−1)th column sub-pixels and the pixel circuits 100 of the (2n)th column sub-pixels to be turned on in a time-sharing manner. Therefore, it is convenient to use the common data line Data to provide different data signals for the pixel circuits 100 sharing the data line Data.

For example, as shown in FIG. 2, the display panel 10 further includes sensing driving control lines SC, and the sensing driving control lines SC are connected with the scan driver 13. The sensing driving control lines SC and the gate lines Gate can share the scan driver 13, that is, the scan driver 13 can provide sensing driving control signals and gate driving signals for the sensing driving control lines SC and the gate lines Gate, respectively.

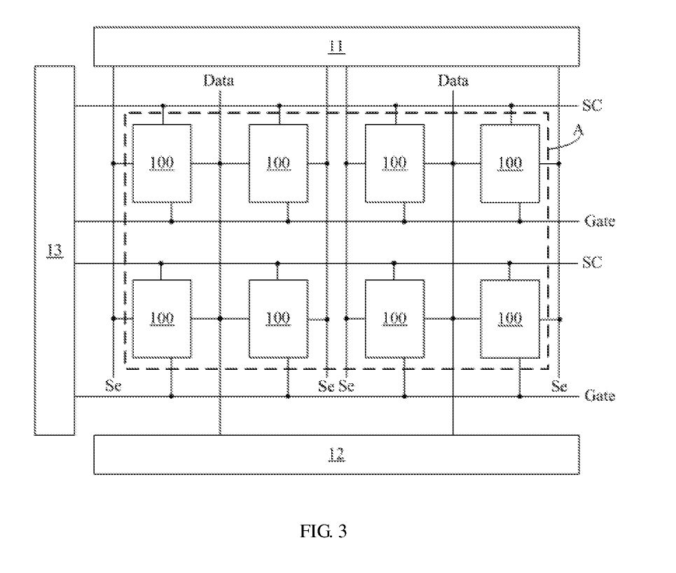

For example, as shown in FIG. 3, in a display panel provided by an embodiment of the present disclosure, the pixel circuits 100 of each row of sub-pixels can be connected with a same gate line Gate. This arrangement enables the pixel circuits 100 of the same row to be turned on at the same time, and the common data line Data provides the same data signals to the pixel circuits 100 in the same row that shares the data line Data. In this case, the light emitting luminance of the organic light emitting diodes in the pixel circuits 100 sharing the data line Data can be controlled by the offset voltages transmitted from the sensing driving lines Se to the pixel circuits 100, and a specific compensation process will be described later in detail. Compared with the arrangement as shown in FIG. 2, the arrangement as shown in FIG. 3 reduces the number of gate lines Gate (the number of gate lines Gate is reduced, for example, to a half of the arrangement as shown in FIG. 2), thereby further increasing the aperture ratio of the display panel, reducing parasitic capacitance, and facilitating wiring and production of the display panel.

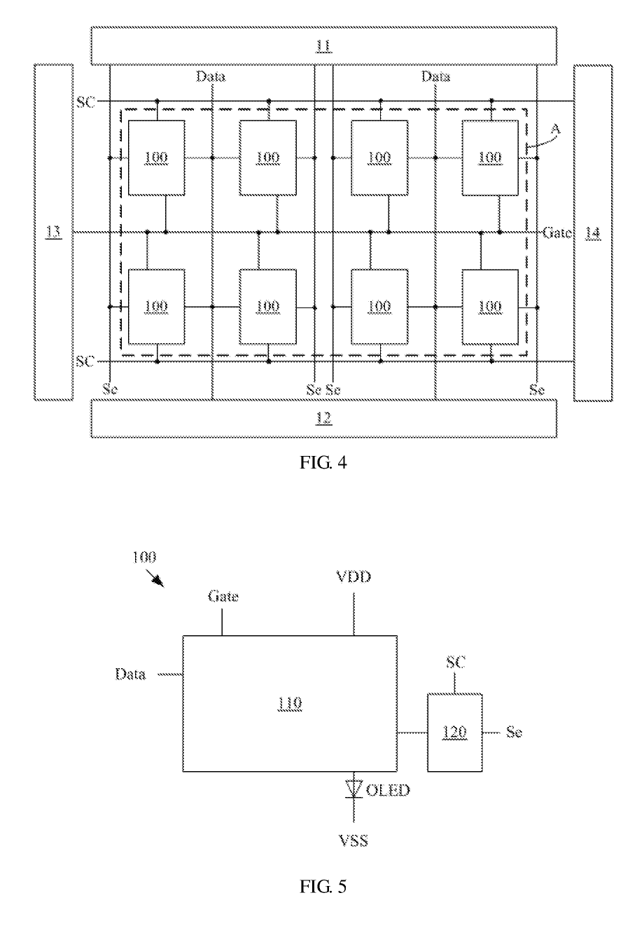

For example, as shown in FIG. 4, in a display panel provided by at least one embodiment of the present disclosure, pixel circuits of the sub-pixels in the (2m−1)th row and pixel circuits of the sub-pixels in the (2m)th row are connected with a same gate line, and m is an integer greater than zero. This arrangement enables the pixel circuits 100 of the sub-pixels in the (2m−1)th row and the pixel circuits 100 of the sub-pixels in the (2m)th row to be turned on at the same time, and the common data line Data provides the same data signals to two rows pixel circuits 100 in two adjacent columns that shares the data line Data. The light emitting luminance of the organic light emitting diodes in the two rows pixel circuits 100 sharing the data line Data can be controlled by the offset voltages transmitted from the sensing driving lines Se to the pixel circuits 100, and a specific compensation process will be described later in detail. Compared with the arrangements of the embodiments shown in FIG. 2 and FIG. 3, the arrangement of the embodiment shown in FIG. 4 reduces the number of gate lines Gate (the number of gate lines Gate is reduced, for example, to a quarter of the arrangement as shown in FIG. 2), thereby further increasing the aperture ratio of the display panel, reducing the parasitic capacitance, and facilitating wiring and production of the display panel. In other words, the display panel can also adopt a double-row scanning manner, that is, two rows of pixel circuits are simultaneously in a charged state at any time, and each pixel circuit can be provided twice as much charging time as the original progressive scan driving manner, which ensures display quality of picture, especially for large-size, high-resolution OLED display products.

For example, the sensing driving control lines SC and the gate lines Gate are not limited to the case of sharing the scan driver 13. As shown in FIG. 4, in at least one embodiment, the display panel 10 further includes a sensing driving control circuit 14 independent of the scan driver 13, the sensing driving control lines SC are connected with the sensing driving control circuit 14, and the sensing driving control circuit 14 can provide the sensing driving control signals for the sensing driving control lines SC. As shown in FIG. 4, the scan driver 13 and the sensing driving control circuit 14 are located on two sides of the sub-pixel array, respectively, and the scan driver 13 and the sensing driving control circuit 14 can also be located on a same side.

For example, because the pixel circuits 100 in different rows and in the same column in the embodiment as shown in FIG. 4 share a sensing driving line Se, the pixel circuits 100 in different rows and in the same column can control the pixel circuits 100 in different rows and in the same column to be connected with the sensing driving line Se in a time-sharing manner through the sensing driving control lines SC, so as to realize that transmitting different compensation voltages to the pixel circuits 100 in different rows and in the same column through the sensing driving line Se.

For example, as shown in FIG. 2 to FIG. 4, in a display panel provided by at least one embodiment of the present disclosure, the data lines Data extend in a same direction as the sensing driving lines Se. This arrangement can facilitate the setting of the data driver 11 and the sensing driver 12 while avoiding overlap of the data lines Data and the sensing driving lines Se, thereby reducing the parasitic capacitance.

For example, as shown in FIG. 2 to FIG. 4, in a display panel provided by at least one embodiment of the present disclosure, only one of the data lines Data or one of the sensing driving lines Se is disposed between the pixel circuits 100 of every two columns sub-pixels. This arrangement can reduce the mutual influence between the data lines Data and the sensing driving lines Se, further reduce the parasitic capacitance and improve the display quality.

For example, in a display panel provided by at least one embodiment of the present disclosure, the data lines Data are formed in the same layer as the sensing driving lines Se. In other words, the data lines Data and the sensing driving lines Se can be formed by using a same patterning process and using a same material layer, which can reduce the number of patterning processes (that is, reduce the usage amount of masks), simplify the production process and reduce the cost.

For example, a display panel 10 provided by at least one embodiment of the present disclosure further includes a first power supply line (not shown in figures), and the first power supply line is configured to provide first power supply voltages VDD to the plurality of pixel circuits 100.

For example, the display panel 10 further includes a second power supply line (not shown in figures), and the second power supply line is configured to provide second power supply voltages VSS to the plurality of pixel circuits 100. For example, the second power supply line can be connected with a cathode of the OLED.

For example, the first power supply voltage VDD can be a high level voltage (for example, 5V), and the second power supply voltage VSS can be a low level voltage (for example 0V or connected with the ground).

For example, as shown in FIG. 5, in a display panel provided by at least one embodiment of the present disclosure, the pixel circuit further includes a light emitting driving circuit 110 and a sensing diving control circuit 120. The light emitting driving circuit 110 is configured to drive the OLED to emit light during operation. The sensing diving control circuit 120 is configured to control connection and disconnection of the sensing driving lines Se with the light emitting driving circuit 110 in the pixel circuit 100.

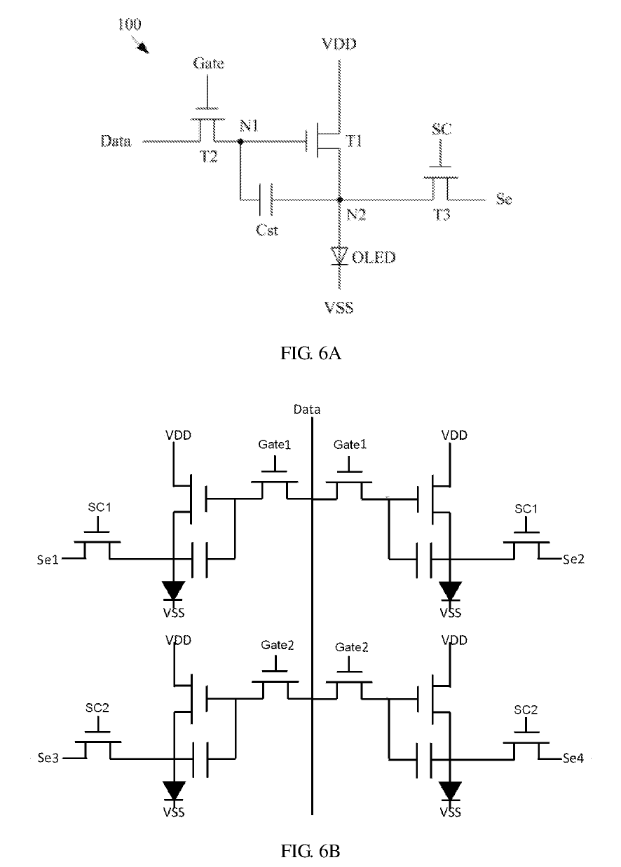

For example, as shown in FIG. 5 and FIG. 6A, in a display panel provided by at least one embodiment of the present disclosure, the light emitting driving circuit 110 includes a first transistor T1 (a driving transistor), a second transistor T2, and a storage capacitor Cst. A first electrode of the first transistor T1 is connected with the first power supply line to receive the first power supply voltage VDD, a gate electrode of the first transistor T1 is connected with a first node N1, and a second electrode of the first transistor T1 is connected with a second node N2. A first electrode of the second transistor T2 is connected with the data line Data to receive the data signal, a gate electrode of the second transistor T2 is connected with the gate line to receive the gate driving signal, and a second electrode of the second transistor T2 is connected with the first node N1. A first end of the storage capacitor Cst is connected with the first node N1, and a second end of the storage capacitor Cst is connected with the second node N2.

For example, the anode of the OLED is connected with the second node N2, and the cathode of the OLED is electrically connected with the second power supply voltage VSS, for example, is electrically connected with the second power supply voltage VSS through the second power supply line.

For example, as shown in FIG. 5 and FIG. 6A, in a display panel provided by at least one embodiment of the present disclosure, the sensing diving control circuit 120 includes a third transistor, a first electrode of the third transistor T3 is connected with the second node N2, a gate electrode of the third transistor T3 is connected with the sensing driving control line SC to receive the sensing driving control signal, and a second electrode of the third transistor T3 is connected with the sensing driving line Se.

FIG. 6B shows four sub-pixels, and each sub-pixel adopts the pixel circuit as shown in FIG. 6A. For example, two sub-pixels adjacent to each other in the first row in the figure share a same data line Data, the two sub-pixels are connected with a same gate line Gate1 and a same sensing control line SC1, but each sub-pixel is connected with a different sensing line Se1 or Se2; two sub-pixels adjacent to each other in the second row in the figure are connected in a same manner. The sub-pixels in the left column of the figure share a same data line Data, they are connected with different gate lines Gate1 and Gate2, they are connected with different sensing control lines SC1 and SC2, and they are connected with different sensing lines Se1 and Se3 or connected with a same sensing line; the sub-pixels in the right column of the figure are connected in a same manner.

It should be noted that all the transistors adopted in the embodiments of the present disclosure can be TFTs, field-effect transistors (FETs) or other switching elements having same characteristics. A source electrode and a drain electrode of the transistor adopted herein can be symmetrical in structure, so the source electrode and the drain electrode of the transistor can have no difference in structure. In the embodiments of the present disclosure, in order to distinguish two electrodes except the gate electrode of the transistor, one electrode is directly described as the first electrode and the other electrode is directly described as the second electrode, so the first electrode and the second electrode of all or portion of the transistors in the embodiments of the present disclosure can be exchanged as required. For example, the first electrode of the transistor in the embodiments of the present disclosure can be the source electrode and the second electrode can be the drain electrode; or the first electrode of the transistor is the drain electrode and the second electrode is the source electrode. In addition, the transistors can be divided into N-type transistors and P-type transistors according to the characteristics of the transistors. The embodiments of the present disclosure do not limit the types of the transistors, and those skilled in the art can use the N-type and/or P-type transistors to implement the embodiments of the present disclosure according to actual requirements.

It should be noted that at least one embodiment of the present disclosure includes but is not limited to the pixel circuit as shown in FIG. 5 or FIG. 6A or FIG. 6B, and can also be a pixel circuit with other structure. For example, in at least one embodiment, the pixel circuit can further include other sub-circuits, such as a reset circuit for resetting the gate electrode of the first transistor, a light emitting control circuit for controlling light emitting of the organic light emitting diode, etc., for example, can further include a transistor, a capacitor and other device to achieve internal compensation and other functions, and details are not described herein again.

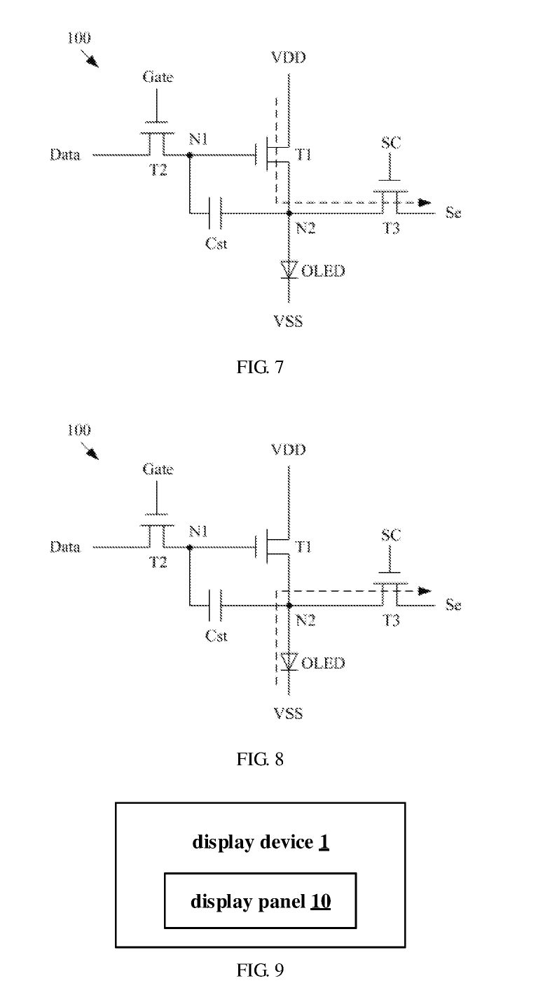

For example, for the pixel circuit as shown in FIG. 6A, in a sensing stage of the organic light emitting diode, the third transistor T3 in the pixel circuit 100 is controlled to be turned on by the sensing driving control line SC, so that the sensing driver 12 senses the light emitting current or the light emitting voltage of the organic light emitting diode through the sensing driving line Se, and thus obtains the electrical parameters of the organic light emitting diode, including changes of the electrical parameters. For example, as shown in FIG. 7, when sensing the current flowing through the first transistor T1 (in a light emitting stage, the current flowing through the first transistor T1 is used for driving the OLED to emit light), the first transistor T1, the second transistor T2 and the third transistor T3 are turned on, and the OLED is turned off. For example, as shown in FIG. 8, when sensing the light emitting voltage of the OLED, the first transistor T1 is turned off, and the second transistor T2 and the third transistor T3 are both turned on, for example, the data signal is at a low level at this time. For example, when the light emitting current or the light emitting voltage sensed by the sensing driver 12 does not match a predetermined light emitting current or light emitting voltage of the pixel circuit, the sensing driver 12 generates the compensation voltage Vse or generates a compensation current according to the sensed light emitting current or the sensed light emitting voltage.

For example, in the light emitting stage, the compensation voltage Vse or the compensation current can be applied to the pixel circuit through the sensing driving line Se, for example, by a voltage source or a current source. For example, the light emitting current Ioled of the OLED satisfies the following saturation current equation:

Ioled=K(Vgs−Vth)²=K(Vdata−Vse−Vth)²

Where K=0.5μₙCoxW/L, μₙ is the channel mobility of the first transistor T1, Cox is the channel capacitance per unit area of the first transistor T1, W and L are the channel width and the channel length of the first transistor T1 respectively, Vth is the threshold voltage of the first transistor T1, and Vgs is the gate-source voltage (difference between a gate electrode voltage and a source electrode voltage of the first transistor T1) of the first transistor T1 (the driving transistor). Because the data line Data is connected with the gate electrode of the first transistor T1, the gate electrode voltage of the first transistor T1 is the data voltage Vdata transmitted by the data line. Because the sensing driving line Se is connected with the source electrode of the first transistor T1 through the third transistor T3, when the third transistor T3 is turned on, the source electrode voltage of the first transistor T1 is the compensation voltage Vse transmitted by the sensing driving control line SC. From the above-described saturation current equation of the OLED, it can be seen that the light emitting current Ioled of the OLED is related to the channel mobility μₙ, the data voltage Vdata transmitted by the data line, the compensation voltage Vse transmitted by the sensing driver 12 through the sensing driving line Se, and the threshold voltage Vth of the first transistor T1. Therefore, the influence of the threshold voltage Vth drift can be compensated by adjusting the magnitude of the compensation voltage Vse, thereby the light emitting current Ioled of the OLED can be the predetermined light emitting current.

In addition, when the channel mobility μₙ of the first transistor T1 drifts, the influence of the drift of the channel mobility μₙ can also be compensated by adjusting the magnitude of the compensation voltage Vse.

In addition, for example, in the embodiments as shown in FIG. 3 and FIG. 4, when the plurality of pixel circuits 100 sharing data lines Data and sharing gate lines Gate. For example, two pixel circuits in FIG. 3 share a same data line Data and a same gate line Gate; for enabling OLEDs in the two pixel circuits 100 to satisfy respective predetermined light emitting current, the sensing driver 12 can transmit the compensation voltages Vse corresponding to each sub-pixel to the two pixel circuits 100 through the different sensing driving lines that are connected with the two pixel circuits 100, and for example, the compensation voltages Vse can be different from each other. For example, in the embodiment as shown in FIG. 4, four pixel circuits share a same data line Data and a same gate line Gate; for enabling OLEDs in the four pixel circuits 100 to satisfy respective predetermined light emitting current, the sensing driver 12 can transmit the compensation voltages Vse corresponding to each sub-pixel to the four pixel circuits 100 through different sensing driving lines that are connected with the four pixel circuits 100, and for example, the compensation voltages Vse can be different from each other. For example, because the pixel circuits 100 in different rows and in the same column as shown in FIG. 4 share a sensing driving line Se, the pixel circuits 100 in different rows and in the same column can control the third transistors T3 of the pixel circuits 100 in different rows and in the same column to be turned on in a time-sharing manner through the sensing driving control lines SC, so as to realize that transmitting different compensation voltages Vse to the pixel circuits 100 in different rows and in the same column through the sensing driving line Se.

For example, the embodiments of the present disclosure are not limited to the case of realizing compensate alone by the compensation voltage Vse transmitted through the sensing driving line Se, but also the data voltage Vdata transmitted through the data line and the compensation voltage Vse transmitted through the sensing driving line Se can be used together to compensate, thereby enabling the adjustable range of the gate-source voltage Vgs of the first transistor T1 to be wider. In this compensation manner, the data driver 11 and the sensing driver 12 can be connected together or both connected with a controller to work together, and to achieve compensation together. This can enable the compensation range to be wider and the compensation to be more accurate.

For example, the light emitting current of the OLED can be sensed in each frame of a display image, and each pixel circuit can be dynamically adjusted by adjusting the magnitude of the compensation voltage Vse or the compensation current, thereby improving display quality.

For example, when the sensed light emitting current or light emitting voltage is less than the predetermined light emitting current or light emitting voltage, the compensation voltage is reduced in one example, or the compensation current is increased in another example.

For example, when the sensed light emitting current or light emitting voltage is greater than the predetermined light emitting current or light emitting voltage, the compensation voltage is increased in one example, or the compensation current is reduced in another example.

For example, a function or a correspondence table between the compensation voltage Vse or the compensation current with the light emitting current Ioled of the OLED, the channel mobility μₙ, the data voltage Vdata transmitted by the data line, and the threshold voltage Vth can be established, and the sensing driver 12 can transmit different compensation voltages Vse or compensation currents to the respective pixel circuits 100 through the sensing driving lines Se according to the function or the correspondence table. For example, the function or the correspondence table can be stored in a storage device for retrieval and use. The storage device can be any suitable type of storage device, such as a semiconductor memory or a magnetic memory.

For example, the sensing driver 12 sensing the light emitting current or the light emitting voltage of the organic light emitting diode through the sensing driving line Se is not limited to the light emitting stage of the organic light emitting diode, and a sensing stage different from the light emitting stage of the organic light emitting diode can also be set for sensing the light emitting current or the light emitting voltage of the organic light emitting diode.

For example, the sensing driver 12 can sense the light emitting current or the light emitting voltage of the organic light emitting diode through the sensing driving line Se in an initial period in the light emitting stage of the organic light emitting diode. For another example, after transmitting the data voltage Vdata to the first node N1 through the data line, the sensing stage is specifically provided, and the sensing driver 12 senses the light emitting current or the light emitting voltage of the organic light emitting diode through the sensing driving line Se during the sensing stage.

For example, in the embodiments as shown in FIG. 3 and FIG. 4, when the plurality of pixel circuits 100 share a data line Data and share a gate line Gate as well, in order to reduce the absolute value of the compensation voltage Vse, thereby reducing the load of the sensing driver 12, the data voltage Vdata that minimizes the sum of the absolute values of the respective compensation voltages Vse of the pixel circuits 100 can be applied to the pixel circuits 100 sharing the data lines Data and the gate lines Gate simultaneously.

For another example, the method of applying data signals is not limited to the case that enables the sum of the absolute values of the respective compensation voltages Vse of the pixel circuits 100 sharing the data lines Data and the gate lines Gate simultaneously to be minimum, and can also apply the data voltages Vdata that enable the maximum of the absolute values of the respective compensation voltages Vse of the pixel circuits 100 sharing the data lines Data and the gate lines Gate simultaneously to be minimum.

An embodiment of the present disclosure further provides a display device 1, as shown in FIG. 9, the display device 1 includes the display panel 10 provided by any embodiment of the present disclosure. In at least one embodiment of the present disclosure, the display device 1 further includes a signal receiving circuit, a video signal decoding circuit, etc. so as to receive and process the video signal, or further includes a modem circuit or an antenna, etc. so as to be coupled with other devices through the network, wireless signals, etc.

For example, the display device 1 provided by an embodiment of the present disclosure can be any product or component with display function such as a mobile phone, a tablet PC, a TV, a display, a notebook computer, a digital picture frame and a navigator.

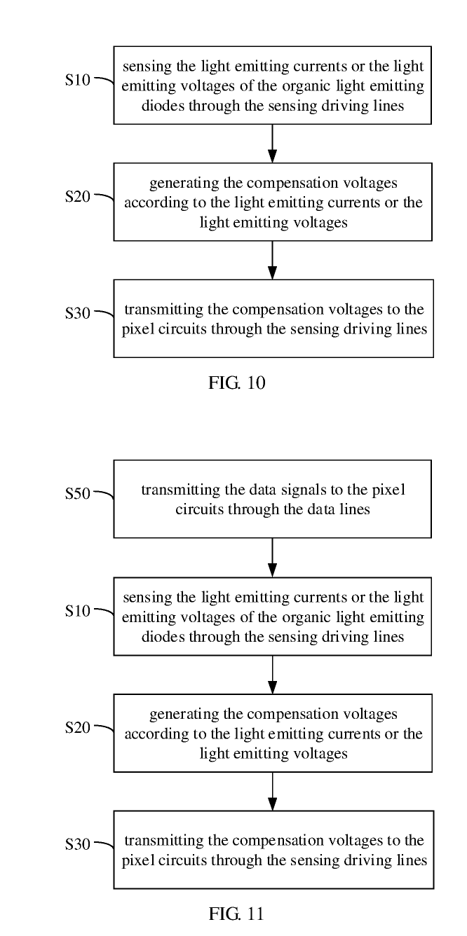

An embodiment of the present disclosure further provides a compensating method for a display panel 10 provided by any embodiment of the present disclosure. As shown in FIG. 10, the method includes the following steps.

Step S10: sensing the light emitting currents or the light emitting voltages of the organic light emitting diodes through the sensing driving lines;

Step S20: generating the compensation voltages according to the light emitting currents or the light emitting voltages; and

Step S30: transmitting the compensation voltages to the pixel circuits through the sensing driving lines.

Herein, the light emitting current or the light emitting voltage is an example of the electrical parameter, and the compensation voltage is an example of the compensation signal, but the embodiments of the present disclosure is not limited to these examples.

For example, in step S20, the sensed light emitting current or the sensed light emitting voltage can be compared with the predetermined light emitting current or the predetermined light emitting voltage, thereby calculating the compensation voltage according to the saturation current equation of the OLED.

For example, when the sensed light emitting current or light emitting voltage is less than the predetermined light emitting current or light emitting voltage, the compensation voltage is decreased.

For example, when the sensed light emitting current or light emitting voltage is greater than the predetermined light emitting current or light emitting voltage, the compensation voltage is increased.

For example, as shown in FIG. 11, in a method provided in at least one embodiment of the present disclosure, before sensing the light emitting currents or the light emitting voltages of the organic light emitting diodes, the method further includes:

Step S05: transmitting the data signals to the pixel circuits through the data lines.

For example, in the embodiments as shown in FIG. 3 and FIG. 4, when the plurality of pixel circuits 100 share a data line Data and share a gate line Gate as well, in order to reduce the absolute value of the compensation voltage Vse, thereby reducing the load of the sensing driver 12, the data voltage Vdata that minimizes the sum of the absolute values of the respective compensation voltages Vse of the pixel circuits 100 can be applied to the pixel circuits 100 sharing the data lines Data and the gate lines Gate simultaneously.

For another example, the method of applying data signals is not limited to the case that enables the sum of the absolute values of the respective compensation voltages Vse of the pixel circuits 100 sharing the data lines Data and the gate lines Gate simultaneously to be minimum, and can also apply the data voltages Vdata that enable the maximum of the absolute values of the respective compensation voltages Vse of the pixel circuits 100 sharing the data lines Data and the gate lines Gate simultaneously to be minimum.

A display panel, a display device and a compensating method provided by the embodiments of the present disclosure can increase the aperture ratio and reduce the parasitic capacitance by sharing data lines between adjacent pixel circuits, and perform the operation of sensing of the light emitting current or the light emitting voltage of the organic light emitting diode by sharing sensing driving lines and compensating for the drift of the threshold voltages of the driving transistors.

What have been described above are only exemplary embodiments of the present disclosure but not to limit the protection scope of the present disclosure, and the protection scope of the present disclosure is determined by the appended claims.

The present application claims the priority of Chinese patent application No. 201710335194.4 filed on May 12, 2017, and the entire content disclosed by the Chinese patent application is incorporated herein by reference as part of the present application.

1. A display panel, comprising:
a plurality of sub-pixels arranged in rows and columns, each of the sub-pixels comprising a pixel circuit;
a plurality of sensing driving lines respectively connected with pixel circuits of the plurality of sub-pixels; and
a sensing driver connected with the plurality of sensing driving lines,
wherein the pixel circuit comprises a light emitting element,
the sensing driver is configured to sense electrical parameters of light emitting elements of the pixel circuits of the plurality of sub-pixels through the plurality of sensing driving lines, and the sensing driver is configured to generate compensation signals according to the electrical parameters, and transmit the compensation signals to the pixel circuits of the plurality of sub-pixels through the plurality of sensing driving lines.

2. The display panel according to claim 1, further comprising a plurality of data lines connected with the pixel circuits of the plurality of sub-pixels,
wherein each of the data lines is connected with pixel circuits of at least two sub-pixels in a same row.

3. The display panel according to claim 1, further comprising a plurality of gate lines connected with the pixel circuits of the plurality of sub-pixels,
wherein pixel circuits of the sub-pixels in each row are connected with a same gate line.

4. The display panel according to claim 1, further comprising a plurality of gate lines connected with the pixel circuits of the plurality of sub-pixels,
wherein pixel circuits of the sub-pixels in a (2m−1)th row and pixel circuits of the sub-pixels in a (2m)th row are connected with a same gate line, and m is an integer greater than zero.

5. The display panel according to claim 1, wherein pixel circuits of the sub-pixels in each column are connected with a same sensing driving line.

6. The display panel according to claim 2, wherein the plurality of data lines extend in a same direction as the plurality of sensing driving lines.

7. The display panel according to claim 2, wherein only one of the data lines or only one of the sensing driving lines is arranged between pixel circuits of every two columns of the sub-pixels.

8. The display panel according to claim 2, wherein the plurality of data lines are formed in the same layer as the plurality of sensing driving lines.

9. The display panel according to claim 2, wherein pixel circuits of the sub-pixels in a (2n−1)th column and pixel circuits of the sub-pixels in a (2n)th column are connected with a same data line, and n is an integer greater than zero.

10. The display panel according to claim 2, wherein the pixel circuit further comprises:
a light emitting driving circuit, configured to drive the light emitting element to emit light during operation, and
a sensing diving control circuit, configured to control connection and disconnection of the sensing driving line with the light emitting driving circuit in the pixel circuit.

11. The display panel according to claim 10, wherein the light emitting driving circuit comprises a first transistor, a second transistor and a storage capacitor,
a first electrode of the first transistor is connected with a first power supply line to receive a first power supply voltage, a gate electrode of the first transistor is connected with a first node, and a second electrode of the first transistor is connected with a second node;
a first electrode of the second transistor is connected with the data line to receive a data signal, a gate electrode of the second transistor is connected with a gate line to receive a gate driving signal, and a second electrode of the second transistor is connected with the first node; and
a first end of the storage capacitor is connected with the first node, and a second end of the storage capacitor is connected with the second node.

12. The display panel according to claim 10, wherein the sensing diving control circuit comprises a third transistor,
a first electrode of the third transistor is connected with the second node, a gate electrode of the third transistor is connected with a sensing driving control line to receive a sensing driving control signal, and a second electrode of the third transistor is connected with the sensing driving line.

13. The display panel according to claim 2, further comprising:
a data driver, configured to provide data signals to the pixel circuits; and
a scan driver, configured to provide gate driving signals to the pixel circuits.

14. The display panel according to claim 1, wherein the light emitting element is an organic light emitting diode,
the electrical parameters comprise a light emitting current or a light emitting voltage of the organic light emitting diode, and
the compensation signals comprise a compensation voltage or a compensation current.

15. A display device, comprising the display panel according to claim 1.

16. A compensating method of the display panel according to claim 1, comprising:
sensing the electrical parameters of light emitting elements through the sensing driving lines;
generating the compensation signals according to the electrical parameters; and
transmitting the compensation signals to the pixel circuits through the sensing driving lines.

17. The compensating method according to claim 16, before sensing the electrical parameters of the light emitting elements, further comprising:
transmitting data signals to the pixel circuits through data lines.

18. The display panel according to claim 2, further comprising a plurality of gate lines connected with the pixel circuits of the plurality of sub-pixels,
wherein pixel circuits of the sub-pixels in each row are connected with a same gate line.

19. The display panel according to claim 2, further comprising a plurality of gate lines connected with the pixel circuits of the plurality of sub-pixels,
wherein pixel circuits of the sub-pixels in a (2m−1)th row and pixel circuits of the sub-pixels in a (2m)th row are connected with a same gate line, and m is an integer greater than zero.
